(19) United States
(12) Patent Application Publication
(10) Pub. No.: US 2012/0105334 A1
(43) Pub. Date: May 3, 2012

(54) COMPUTING DEVICE WITH FLAT TOUCH SURFACE

(75) Inventors: Curt Aumiller, Redmond, WA (US); Bernie Schultz, Bothell, WA (US); Rajesh Manohar Dighde, Redmond, WA (US); August Valentin Isabelo de los Reyes, Bellevue, WA (US); Jennifer McCormick, San Francisco, CA (US)

(73) Assignee: MICROSOFT CORPORATION, Redmond, WA (US)

(21) Appl. No.: 12/938,999

(22) Filed: Nov. 3, 2010

(51) Int. Cl. G06F 3/041

(52) U.S. Cl. 345/173

(57) ABSTRACT

A computing device includes a seamless front panel member extending across an entire front face of the computing device. The computing device further includes a display engine configured to selectively display images on a display window of the seamless front panel member and a touch-detection engine configured to detect touch inputs directed to the display window of the seamless front panel member.

### BACKGROUND

Advances in computing systems have led to corresponding advances in the ways in which human users interact with computing systems. In particular, the input devices with which a user controls the computing system have improved. Some computing systems utilize keyboards to receive typed computing commands that are executed by the computing system. Some computing systems utilize mice, trackballs, track pads, and/or other pointer devices for controlling a graphical user interface. Some computing systems utilize touch screens that allow users to more directly control a graphical user interface by physically touching the screen displaying the graphical elements of the user interface. Improvements in input devices can help new computer users quickly learn how to operate a computing system while also improving the user experience of more advanced users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computing device in accordance with embodiments of the present disclosure includes a seamless front panel member extending across an entire front face of the computing device. The computing device further includes a display engine configured to selectively display images on a display window of the seamless front panel member and a touch-detection engine configured to detect touch inputs directed to the display window of the seamless front panel member.

### BRIEF DESCRIPTION OF THE DRAWINGS

FIG. 1 shows an example surface computing device in accordance with embodiments of the present disclosure.

FIG. 2 shows a front face of the example surface computing device of FIG. 1.

FIGS. 3A and 3B show portions of example surface computing devices having coplanar display surfaces and frames.

FIG. 4 schematically shows the example surface computing device of FIG. 1.

### DETAILED DESCRIPTION

The present disclosure is directed to surface computing devices that serve as both a display and a touch input device. As a display, a surface computing device in accordance with the present disclosure is capable of visually presenting images, including, but not limited to, user interfaces, application interfaces, visual media, television programming, and the like. As a touch input device, the surface computing device is able to detect user touches directed to a display window of the surface computing device. Such user touches can be interpreted as user input commands, which can be used to control various aspects of the surface computing device and/or various programs running on the surface computing device.

Surface computing devices may utilize a variety of different technologies for visually presenting images and/or detecting touch inputs. Surface computing devices in accordance with the present disclosure are not limited to any particular technologies. As nonlimiting examples, display images may be presented by liquid crystal display panels, plasma display panels, light emitting diode display panels, rear projection displays, including rear projection displays that utilize a wedge-shaped light guide, or virtually any other display technology. Any suitable touch-detection technology that is compatible with the chosen display technology may be used. For example, embodiments that employ a rear projection display technology may use a vision-based touch detection technology in which one or more infrared cameras are used to detect infrared reference light that is reflected from a user's finger touching the display window. As another example, embodiments that use a liquid crystal display panel may include a capacitive array to detect user touches directed at the display window. These and other suitable technologies are within the scope of this disclosure.

In some embodiments, a surface computing device is configured to be used with a horizontal orientation. When orientated horizontally, a surface computing device may accommodate use by two or more different users, who can gather around the surface computing device in much the same way as people can gather around a table. In this configuration, two or more users can easily touch the display window and control various aspects of the surface computing device and/or programs running on the surface computing device.

Many obstacles can serve as a barrier to a first-time user presented with an opportunity to interact with and control a horizontally-orientated surface computing device. As one example, some users are hesitant to treat a surface computing device as a conventional table and are reluctant to place beverages, personal items, or other objects on the surface computing device. This can deter from a user's experience with the surface computing device.

Furthermore, design characteristics of conventional displays are not suitable for surface computing. Conventional displays are configured for vertical mounting. As such, conventional displays are not designed to support a user's leaning weight and/or objects that a user may place on a surface computing device. Furthermore, conventional displays have seams on the forward facing side of the display, and such seams serve as liquid ingress channels if the conventional display is used horizontally. For these and many other reasons, conventional displays are not suitable for horizontal tabletop usage.

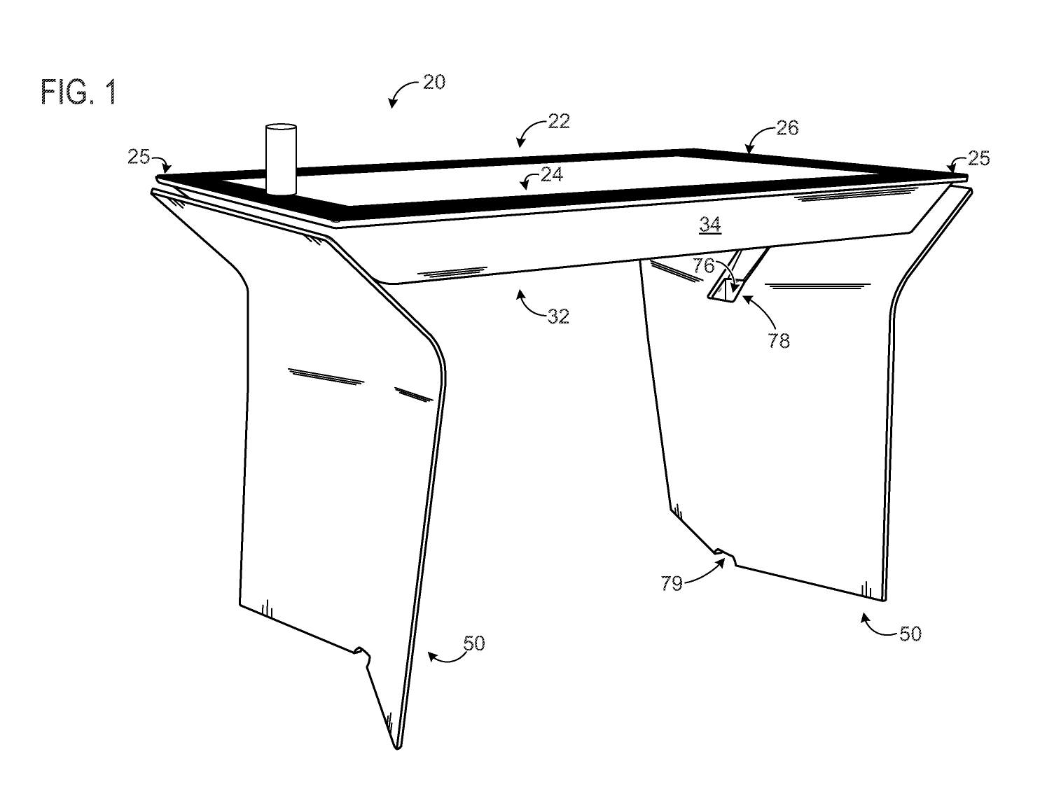

FIG. 1 shows an example surface computing device 20 in accordance with an embodiment of the present disclosure. Surface computing device 20 includes a front face 22 including a display window 24 configured to display images. Surface computing device 20 may be configured to display images on display window 24 in any suitable way. For example, surface computing device 20 may include a display engine configured to selectively display images on display window 24. The display engine may utilize any suitable technologies to visually present images as described above, including but not limited to a liquid crystal display panel, a plasma display panel, a light emitting diode display panel, a rear projection display, including a rear projection display that utilizes a wedge-shaped light guide, or virtually any other display technology. Surface computing device 20 may further include a touch-detection engine configured to detect touch inputs directed to display window 24. In this way, surface computing device 20 serves as both a display and an interactive touch input device. The touch-detection engine may utilize any suitable technologies compatible with the chosen display technology. As described above, such technologies include but are not limited to a vision-based touch detection technology, a capacitive array to detect user touches directed at the display window, etc.

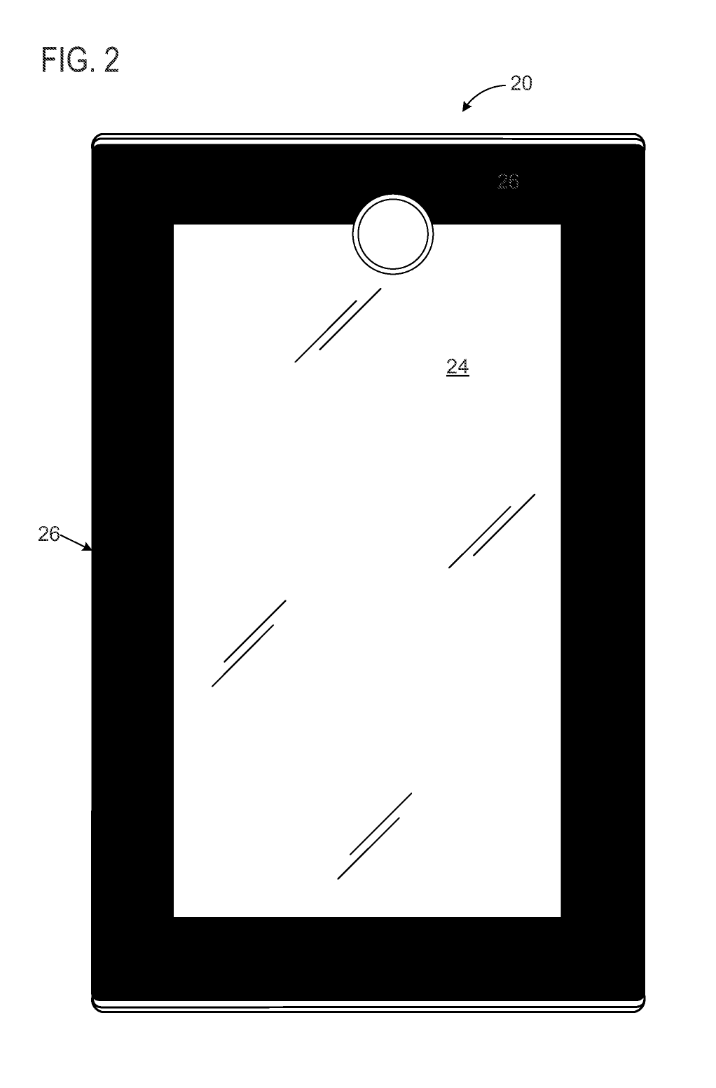

Front face 22 may be constructed as a seamless front panel member 25 extending across an entire front face of the surface computing device, as shown in FIGS. 1 and 2. The seamless front panel member 25 may be a monolithic panel of glass, plastic, or another substantially transparent material or combination of materials.

The size of the seamless front panel member 25 may be selected based on the desired size of the surface computing device. It is to be understood that the seamless front panel member 25 may be sufficiently large to accommodate a plurality of users accessing the surface computing device from different sides of the surface computing device when the surface computing device is in a substantially horizontal orientation. In some embodiments, the seamless front panel member may be at least a 2 foot by 2 foot rectangle. In some embodiments, the seamless front panel member may be at least a 4 foot by 3 foot rectangle. In the illustrated embodiment, the seamless front panel member is two feet four inches by three feet seven inches.

The material(s) and/or thickness of material(s) used to construct the seamless front panel member may be selected such that the panel member is able to support the leaning weight of a plurality of users and/or the weight of the items such users place on the seamless front panel member 25. In some embodiments, the seamless front panel member is configured to support at least a 100 pound static load at a center of the seamless front panel member when the surface computing device is in a substantially horizontal orientation. In some embodiments, the seamless front panel member may be configured to support a heavier load, such as a 250 pound static load at a center of the seamless front panel member. The seamless front panel may include one or more of the following: metal, glass, strengthened glass, acrylic, polycarbonate, and CR-39. The seamless front panel may be any suitable thickness depending on the material(s) it is constructed from. In some embodiments, the seamless front panel may be 0.5-2.0 mm thick. Materials and/or thicknesses other than those listed above may be used without departing from the scope of this disclosure.

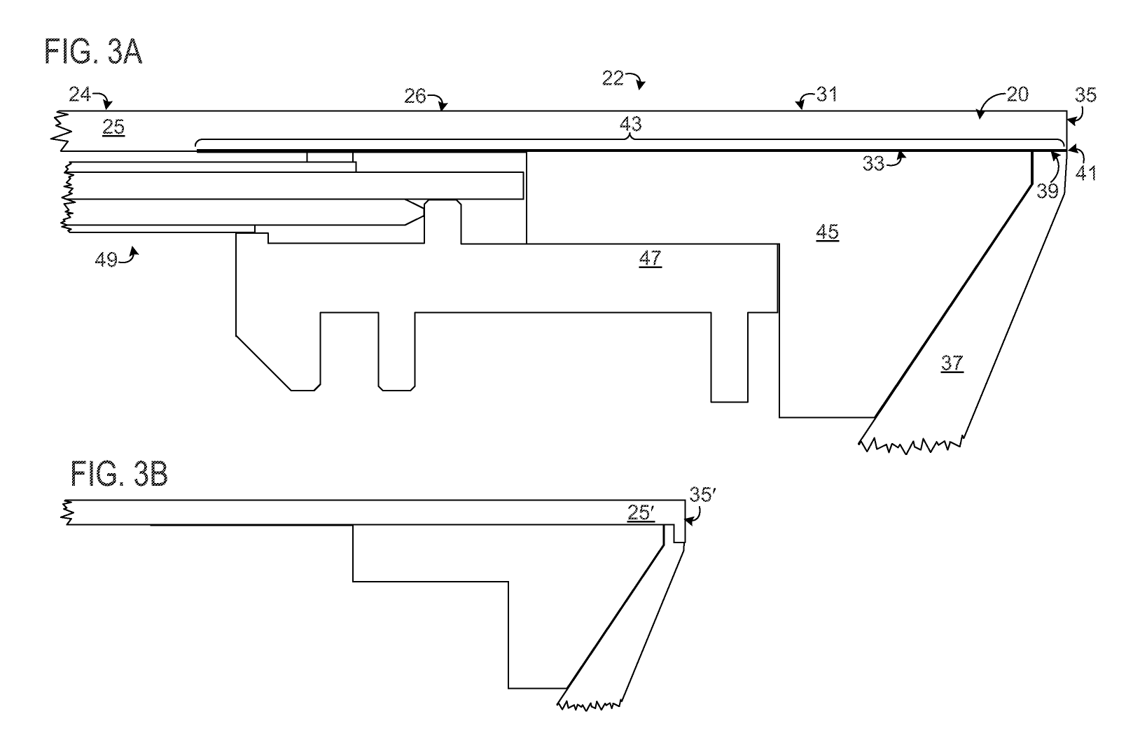

FIG. 3A somewhat schematically shows an example cross section of an edge of the surface computing device 20. Seamless front panel member 25 includes a planar front side 31, a back side 33, and a perimeter edge 35. As can be seen in FIG. 3, the surface computing device 20 also includes a housing assembly 37 including a mounting lip 39 housing assembly 37 may be constructed as one or more pieces from a variety of suitable materials including, but not limited to, plastics and metals.

As shown in FIG. 3A, mounting lip 39 of housing assembly 37 is positioned adjacent to the back side 33 of the seamless front panel member. Furthermore, mounting lip 39 of housing assembly 37 is aligned with the perimeter edge 35 of the seamless front panel member. In this way, the front side of the seamless front panel member is unobstructed from edge to edge. In other words, the front face 22 of the surface computing device is completely smooth and flat without any seams and/or joints. Such a smooth flat surface enables the surface computing device 20 to serve as a functional table, on which drinks and other objects may be placed and/or slid.

As shown in FIG. 3B, in some embodiments a seamless front panel member 25′ may include a turned down perimeter edge 35′. Such a turned down edge may provide mechanical stability and/or further improve the blocking of liquid penetration.

As shown in FIG. 1, the planar front side of the seamless front panel member 25 can be configured as the highest portion of the surface computing device when the surface computing device is in a substantially horizontal orientation. As such, no other structure creates a lip or other liquid containing feature on the front face of the seamless front panel member. Any liquid spills on the planar front side of the seamless front panel member are able to naturally flow over the sides of the seamless front panel member without obstruction from the housing assembly or another structure. As such, surface computing device 20 does not cause the pooling of spilt liquids, nor does surface computing device 20 include liquid ingress channels on the front face of the surface computing device.

In some embodiments, the surface computing device 20 may include a liquid-tight sealing agent 41 between the housing assembly and the back side of the seamless front panel member. Such a liquid-tight sealing agent can help limit, if not completely prevent, any liquid from penetrating the joint between the housing assembly and the seamless front panel member. In some embodiments, the liquid-tight sealing agent may include a gasket. In some embodiments, the liquid-tight sealing agent may include a bead of plumber's putty or the like.

In some embodiments, a perimeter portion 43 of the back side of the front panel member is treated to form an opaque frame 26 defining a display window 24. For example, the perimeter portion of the back side of the front panel member may be painted black. Treating the perimeter portion to create an opaque frame allows the otherwise transparent front panel member to hide the housing assembly 37 and other components when viewed from the front. However, the frame does not interfere with the flatness and/or the smoothness of the front side of the front panel member. In other embodiments, a frame may include one or more structural pieces aligned with the back side of the front panel member. As a nonlimiting example, a frame may include a thin rectangular sheet of plastic or metal with a rectangular opening defining the display window 24. Such a thin sheet may be positioned under the seamless front panel member against the back side of the seamless front panel member.

Frame 26 may provide functional as well as aesthetic enhancements to the user experience. For example, frame 26 may be configured to support objects set on frame 26 without obstructing display window 24. As briefly introduced above, when using horizontal interactive displays, users may desire to set personal items down on the seamless front panel member (e.g., glassware, a wallet, a phone, etc.) so that their hands are free for interaction. Thus, frame 26 may provide such an area for personal objects.

Frame 26 may have any suitable shape. In some embodiments, front face 22 and display window 24 may be substantially rectangular, as depicted in FIGS. 1 and 2. As such, frame 26 surrounding display window 24 may be a substantially-rectangular frame which maintains a width around the entirety of display window 24, as shown in FIG. 2. Frame 26 may have any suitable width. Examples of suitable widths include but are not limited to at least 3 inches, and at least 4 inches. It is to be understood that the frame may be smaller. In some embodiments, the display window 24 may extend to the edge of the front face without a frame.

As shown in FIG. 3A, surface computing device 20 may include a registration key 45 fixed to the back side 33 of the seamless front panel member 25. The registration key may be fixed to back side 33 in any suitable way. As nonlimiting examples, the registration key may be fixed to the back side via a pressure sensitive adhesive or an epoxy (e.g., Dupont Vertak DVA series, 3M Optically Clear Adhesive, and/or Dowel Corning Sylgard 184).

The registration key may be fixed to a precise location on the back side so that the registration key can be used to accurately position the seamless front panel member 25. In particular, the registration key may be mounted to a mount 47 located interior the housing assembly. Such a mount may be located at a known position relative to various aspects of the surface computing device so that when the registration key is mounted to the mount, the seamless front panel member will be positioned as desired relative to those aspects of the surface computing device. In this way the registration key may be used to align the perimeter edge 35 of the front panel member with the mounting lip 39 of the housing assembly to create a smooth transition between the front panel member and the housing assembly. Furthermore, the registration key may be used to position the seamless front panel member 25 in a predetermined position relative to the display engine 49 and/or touch-detection engine 90. As such, frame 26 and/or aspects of the touch-detection engine may be properly aligned with the display engine (e.g., a liquid crystal display panel).

Turning back to FIG. 1, surface computing device 20 further includes a rear face 32 opposite front face 22. Rear face 32 may be any suitable shape and/or size. For example, in some embodiments, the rear face may be substantially rectangular. In some embodiments, rear face 32 may be sized such that a planar projection of rear face 32 onto a plane of display window 24 is smaller than a planar projection of front face 22 onto the plane of display window 24. However, in other embodiments, the planar projection of rear face 32 onto the plane of display window 24 may be sized substantially the same as display window 24.

Continuing with FIG. 1, surface computing device 20 further comprises a beveled edge 34 between front face 22 and rear face 32. Beveled edge 34 may be beveled inward relative to a normal to display window 24, so as to give the illusion of less depth, further enhancing the visual perception of a thinner form factor.

Beveled edge 34 may be angled relative to a normal of display window 24 at any suitable angle. In some embodiments, the beveled edge may be angled 40 degrees or more relative to a normal to front face 22.

Surface computing device 20 may be mounted in any suitable manner, for example, based on the use environment and/or a user's ergonomic and/or accessibility needs. As such, in some embodiments, surface computing device 20 may be wall-mounted, for example, using a Video Electronics Standards Association (VESA) mount.

However, in some embodiments, surface computing device 20 may further include a leg assembly 50. Leg assembly 50 may be configured to hold front face 22 at any suitable orientation. For example, in some embodiments, leg assembly 50 may be configured to hold front face 22 in a substantially horizontal orientation above a support surface, such as the floor. However, it should be appreciated that such an orientation is nonlimiting, and in other embodiments, the leg assembly may hold the front face at any other desired orientation, such as at an angle with respect to the support surface.

In some embodiments, leg assembly 50 may be mounted to beveled edge 34. Such mounting may be done in any suitable way, so as to provide optionality and flexibility based on the use environment (e.g., commercial, educational, public, etc.). For example, the leg assembly may provide for a horizontal table-like orientation, as described above, at any suitable height. A surface computing system in a public use environment may be at a height appropriate for standing users, or seated users, whereas a surface computing system in a home-use environment may be substantially lower, such as at a standard coffee-table height. As another example, the leg assembly may be mounted so as to provide a tilted display window 24, such as that suitable for a public kiosk. Further yet, in addition to providing optionality and flexibility based on the use environment, the leg assembly may provide flexibility from a user-standpoint, for ergonomic purposes, or to comply with accessibility standards of the Americans with Disabilities Act (ADA). Further, in some embodiments, leg assembly 50 may be mounted to beveled edge 34 via VESA mounts.

Further, one or more legs of the leg assembly may include an interior channel configured to hide cords. FIG. 1 illustrates an example interior channel 76. Such integrated cable routing and management may allow for more flexible input/output options. The interior channel may be positioned within a shaped panel forming a leg of the leg assembly. As such, an inner face of a shaped panel may include an aperture opening to an upper portion of the interior channel. Thus, for the case of interior channel 76 included within the shaped panel, the leg assembly may further include an aperture opening 78 to an upper portion of interior channel 76. Aperture opening 78 may be utilized, for example, for receiving cords directed into interior channel 76. In this way, the cords are hidden from view within the shaped panel of the leg assembly, providing a more aesthetically pleasing surface computing device and more flexible input/output options. In some embodiments, the cords may then exit interior channel 76 at a lower opening 79.

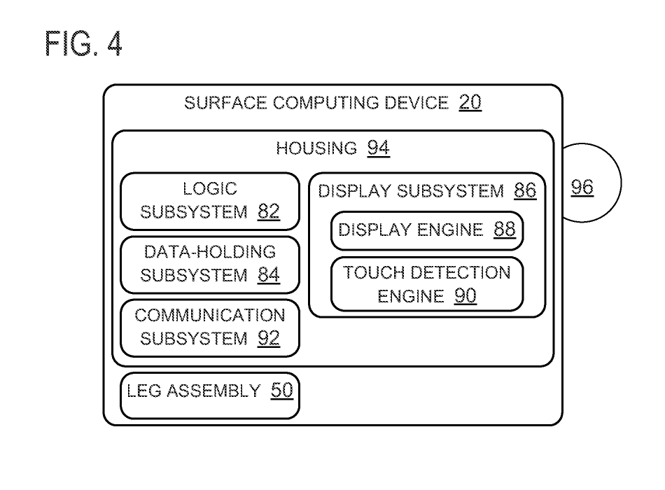

FIG. 4 schematically shows surface computing device 20. Surface computing device 20 includes logic subsystem 82, data-holding subsystem 84, a display subsystem 86 comprising a display engine 88 and touch-detection engine 90, communication subsystem 92, housing 94, leg assembly 50, and/or other components not shown in FIG. 4. Surface computing device 20 may also optionally include auxiliary user input devices such as keyboards, mice, game controllers, cameras, and/or microphones, for example.

Logic subsystem 82 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 84 may include one or more physical, non-transitory, devices configured to hold data and/or instructions executable by the logic subsystem to implement the herein described methods and processes. When such methods and processes are implemented, the state of data-holding subsystem 84 may be transformed (e.g., to hold different data).

Data-holding subsystem 84 may include removable media and/or built-in devices. Data-holding subsystem 84 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 84 may include devices with one or more of the following characteristics: volatile, nonvolatile, dynamic, static, read/write, read-only, random access, sequential access, location addressable, file addressable, and content addressable. In some embodiments, logic subsystem 82 and data-holding subsystem 84 may be integrated into one or more common devices, such as an application specific integrated circuit or a system on a chip.

FIG. 4 also shows an aspect of the data-holding subsystem in the form of removable computer-readable storage media 96, which may be used to store and/or transfer data and/or instructions executable to implement the herein described methods and processes. Removable computer-readable storage media 96 may take the form of CDs, DVDs, HD-DVDs, Blu-Ray Discs, EEPROMs, and/or floppy disks, among others.

The terms “module,” “program,” and “engine” may be used to describe an aspect of surface computing device 20 that is implemented to perform one or more particular functions. In some cases, such a module, program, or engine may be instantiated via logic subsystem 82 executing instructions held by data-holding subsystem 84. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

Display engine 88 may be configured to display images in any suitable way. As nonlimiting examples, display images may be presented by a liquid crystal display panel, a plasma display panel, a light emitting diode display panel, a rear projection display, including a rear projection display that utilizes a wedge-shaped light guide, or virtually any other display technology.

Touch-detection engine 90 may utilize any suitable touch-detection technology that is compatible with the chosen display technology. As nonlimiting examples, touch inputs may be detected by vision-based touch detection technology, a capacitive array to detect user touches directed at the display window, resistive touch detection technologies, etc. Further, touch-detection engine 90 may be configured to detect any suitable input touches, including single touches, multi-touches, touch-gestures, and the like.

It should be appreciated that housing 94 of surface computing device 20 and/or leg assembly 50 are not intended to be limiting in any way. The housing may be configured in other shapes, sizes, etc. and may be made of different materials without departing from the scope of this disclosure. Further, the leg assembly may include leg units of different heights, shapes, materials, configurations, etc. and/or a different number of leg units and/or different mounting points, etc.

Communication subsystem 92 may be configured to communicatively couple surface computing device 20 with one or more other computing devices. Communication subsystem 92 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow surface computing device 20 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A surface computing device, comprising:
a seamless front panel member extending across an entire front face of the surface computing device, the seamless front panel member having a planar front side, a back side, and a perimeter edge;
a housing assembly including a mounting lip adjacent to the back side of the seamless front panel member and aligned with the perimeter edge of the seamless front panel member;
a display engine housed within the housing assembly and configured to selectively display images on a display window of the seamless front panel member;
a registration key fixed to the back side of the seamless front panel member and configured to position the seamless front panel member in a predetermined position relative to the display engine;
a touch-detection engine configured to detect touch inputs directed to the display window of the seamless front panel member; and
a leg assembly operatively connected to the housing assembly and configured to hold the seamless front panel member in a substantially horizontal orientation above a support surface.

2. The surface computing device of claim 1, where the planar front side is a highest portion of the surface computing device when the surface computing device is in the substantially horizontal orientation.

3. The surface computing device of claim 1, where the seamless front panel member is configured to support at least a 100 pound static load at a center of the seamless front panel member when the surface computing device is in the substantially horizontal orientation.

4. The surface computing device of claim 1, where the seamless front panel member is at least a 2 foot by 2 foot rectangle.

5. The surface computing device of claim 1, where the display engine includes a liquid crystal display panel.

6. The surface computing device of claim 1, where a perimeter portion of the back side is treated to form an opaque frame defining the display window.

7. The surface computing device of claim 1, further comprising a liquid-tight sealing agent between the housing assembly and the back side of the seamless front panel member.

8. A computing device, comprising:
a seamless front panel member extending across an entire front face of the computing device;
a display engine configured to selectively display images on a display window of the seamless front panel member; and
a touch-detection engine configured to detect touch inputs directed to the display window of the seamless front panel member.

9. The computing device of claim 8, further comprising a leg assembly configured to hold the seamless front panel member in a substantially horizontal orientation above a support surface.

10. The computing device of claim 8, where the seamless front panel member has a planar front side and a back side, and where the computing device further comprises a housing assembly adjacent to the back side of the seamless front panel member.

11. The computing device of claim 10, further comprising a liquid-tight sealing agent between the housing assembly and the back side of the seamless front panel member.

12. The computing device of claim 10, where the seamless front panel member has a perimeter edge and where the housing assembly is aligned with the perimeter edge.

13. The computing device of claim 8, where the seamless front panel member has a planar front side, and where the planar front side is a highest portion of the computing device when the computing device is in a substantially horizontal orientation.

14. The computing device of claim 8, where the seamless front panel member is configured to support at least a 100 pound static load at a center of the seamless front panel member when the computing device is in a substantially horizontal orientation.

15. The computing device of claim 8, where the seamless front panel member is at least a 2 foot by 2 foot rectangle.

16. The computing device of claim 8, where the display engine includes a liquid crystal display panel.

17. The computing device of claim 8, where the seamless front panel member has a planar front side and a back side, and where a perimeter portion of the back side is treated to form an opaque frame defining the display window.

18. The computing device of claim 8, where the seamless front panel member has a planar front side and a back side, and where the computing device further includes a registration key fixed to the back side of the seamless front panel member and configured to position the seamless front panel member in a predetermined position relative to the display engine.

19. A surface computing device, comprising:
a housing assembly having a mounting lip;
a mount interior the housing assembly;
a front panel member having a planar front side, a back side, and a perimeter edge;
a registration key fixed to the back side of the front panel member and mounted to the mount interior the housing assembly to align the perimeter edge of the front panel member with the mounting lip of the housing assembly;
a display engine housed within the housing assembly and configured to selectively display images on a display window of the front panel member; and
a touch-detection engine configured to detect touch inputs directed to the display window of the front panel member.

20. The surface computing device of claim 19, further comprising a leg assembly operatively connected to the housing assembly and configured to hold the front panel member in a substantially horizontal orientation above a support surface.
